(19) United States
(12) Patent Application Publication
(10) Pub. No.: US 2010/0167005 A1
(43) Pub. Date: Jul. 1, 2010

(54) DIRECTLY DECORATABLE COMPOSITE MATERIALS, METHOD FOR THEIR MANUFACTURE AND THEIR USE

(75) Inventors: Michael Ketzer, Collenberg (DE); Klaus Friedrich Gleich, Highlands Ranch, CO (US); Bernd Christensen, Wertheim (DE); Alan Jaffee, Bowling Green, OH (US); Phil Miele, Highlands Ranch, CO (US); Glenda Bennett, Toledo, OH (US); Bernhard Eckert, Freudenberg-Boxtal (DE); Annette Albrecht, Wertheim (DE)

Correspondence Address: JOHNS MANVILLE, 10100 WEST UTE AVENUE, PO BOX 625005, LITTLETON, CO, 80162-5005, US

(73) Assignee: JOHNS MANVILLE, Denver, CO (US)

(21) Appl. No.: 12/527,713

(22) PCT Filed: Feb. 20, 2008
(86) PCT No.: PCT/EP08/01303

§ 371 Date: Mar. 9, 2010

(30) Foreign Application Priority Data
Feb. 21, 2007 (DE) 10 2007 008 423.6
Feb. 21, 2007 (DE) 10 2007 008 424.4
Mar. 16, 2007 (DE) 10 2007 012 651.6
Jun. 18, 2007 (DE) 10 2007 028 531.2

(51) Int. Cl. B32B 3/12; B32B 37/00; B32B 38/14; B05D 5/00; B32B 3/00; B32B 5/16; B32B 21/04; B32B 29/00; D03D 15/00; D04B 21/00

(52) U.S. Cl. 428/116; 156/60; 156/277; 427/288; 428/172; 428/195.1; 428/323; 428/537.1; 428/537.5; 442/181; 442/304; 442/334

(57) ABSTRACT

The invention relates to directly decoratable and/or printable composite materials suitable in particular as materials in interior finishing, for linings, constructions and for the manufacture of furniture and similar products.

### BACKGROUND

The invention relates to directly decoratable and/or printable composite materials suitable in particular as materials in interior finishing, for linings, constructions and for the manufacture of furniture and similar products.

Composite materials are increasingly replacing traditional building materials as construction materials and must be adapted for manifold applications. Thus, on the one hand a sufficient mechanical stability is required and on the other hand a good processability and low weight are necessary. There has therefore been no lack of attempts to improve existing composite materials.

Thus, the combining of wood materials, which are manufactured from comminuted wood and the use of binders, with further materials is already known. To this end, the two materials are usually laminated and form a composite material. The selection and combination of the materials can improve the mechanical properties and at the same time a reduction, e.g. of the weight, can be achieved.

During processing the previously described composite materials are often subjected to further finishing steps, e.g., a lacquering or printing. This places high demands regarding smoothness and tolerances on the surfaces to be worked so that the surfaces to be worked must be pre-worked in an expensive manner and often several times in order that a later finish is possible at all.

Composite materials based on wooden materials and non-woven fabrics strengthened by a “B” stage binder are known from WO2006/031522. The base non-woven fabrics are known, e.g., from U.S. Pat. No. 5,837,620, U.S. Pat. No. 303,207 and U.S. Pat. No. 6,331,339.

It is known from WO2006/031522 that further additives can be added to the binder or the non-woven fabric but more detailed data about the later usage and the processing are not given.

There was therefore the task of finding composite materials that can be subjected to further finishing steps, e.g., lacquering or printing, without the surfaces to be worked having to be pre-worked in an expensive manner and often several times.

Furthermore, there is the task of finding composite materials with the previously cited properties that can be finished to the extent possible with known working processes and systems.

### SUMMARY

The present invention has as subject matter a composite material comprising:
1. a carrier,
2. at least one textile surface structure laminated onto at least one of the two sides of the carrier, which textile surface structure has at least one finally hardened B-stage binder and which can optionally be provided with at least one functional material,

characterized in that the side(s) of the composite material equipped with the textile surface structure has/have a surface quality such that it can be directly printed or lacquered by powder lacquering or lacquered electrostatically.

Also provided is a method for manufacturing a composite material comprising supplying a carrier; applying a textile surface structure onto at least one surface of the carrier to provide a pre-laminated construction, wherein the textile surface structure has at least one binder present in a B-stage state; and laminating the pre-laminated construction under pressure and heat so that the binder present in the B-stage state receives its final hardening.

Further provided is a printed or lacquered composite material comprising a carrier; at least one textile surface structure applied onto at least one side of the carrier; and at least one lacquer or printed layer or foil. The at least one lacquer or printed layer or foil is applied without primer layers being used. The textile surface structure has at least one finally hardened B-stage binder

Additionally provided is a method for printing or lacquering composite materials comprising directly printing or lacquering a composite material, wherein primer layers are not used. The composite material comprises a carrier and at least one textile surface structure applied on at least one side of the carrier. The textile surface structure has at least one finally hardened B-stage binder.

### DETAILED DESCRIPTION

The composite materials in accordance with the invention have a very good surface quality, expressed as thickness variation, on the side(s) equipped with the textile surface structure. The thickness variation of the composite material in accordance with the invention is preferably less than 0.1 mm, preferably less than 0.01 mm.

It is known that composite materials can be printed and/or lacquered but the surface to be worked must first be prepared by suitable measures. Usually, the surfaces are smoothed for this by abrasive measures, e.g., grinding. The composite material in accordance with the invention is helpful here. The surface quality of the side of the carrier, which side is equipped with the textile surface structure, is already so good that a direct workability is given. Thus, the abrasive measures can be eliminated.

A further preparatory measure in the printing or lacquering of composite materials is to provide the surface to be worked with so-called primer layers. Fillers, especially water-soluble fillers are understood to be primer layers or primer materials in the sense of the present invention. In as far as the surfaces to be worked have a low surface quality, relatively thick primer layers or several primer layers are necessary.

It was only possible to print and/or lacquer the surface by these measures (grinding and/or primer coating).

These measures (primer coating) can be entirely or at least partially eliminated with the aid of the composite materials in accordance with the invention. This represents a significant simplification in the printing/lacquering of composite materials, in particular in the case of composite materials comprising a carrier of wooden material.

Depending on the lacquering or printing technique, so-called base coatings are also applied on the side(s) of the composite material to be worked, which sides are equipped with the textile surface structure. These single-coated or multi-coated base coatings form the pressure support and are known in the state of the art. The base coatings can also contain pigments, depending on the area of application.

The carrier used in accordance with a) is preferably wooden materials, papers, cork, cardboards, mineral plates and/or so-called honeycombs. Honeycombs are structural components with three-dimensional reinforcement structures that make possible an extraordinary stability and strength with low weight at the same time on account of their construction (bee honeycomb structure). Such honeycombs have been used for some time in many areas of application, among others also as inner reinforcement of plate-shaped elements in the construction area or in furniture.

The wooden materials are plate-shaped or strand-shaped wooden materials manufactured by mixing the different wooden particle forms with natural and/or synthetic binding agents during a hot pressing. The wooden materials used in accordance with the invention preferably comprise plywood or laminated wood, wood-chip material, especially chipboards and OSB (Oriented Strand Boards), wood fiber material, especially porous wood fiber boards, open-diffusion wood fiber boards, hard (high-density) wood fiber boards (HDF) and medium-density wood fiber boards (MDF), and Arboform. Arboform is a thermoplastically processable material of lignin and other wood components.

Moreover, the carriers in accordance with the invention comprise materials of wood fiber materials, cellulose fibers, natural fibers or their mixtures and of a thermoplastic binder, the portion of the binder being more than 15% by weight. The materials are optionally reinforced by glass fibers, basalt fibers or synthetic fibers.

The papers are preferably papers on the basis of natural, synthetic, mineral or ceramic fibers or also of mixtures of these fiber types.

The cardboards are preferably cardboards on the basis of natural and/or synthetic fibers, which also comprise mineral and/or ceramic fibers as well as mixtures of these fiber types.

The mineral plates are preferably commercial mineral cardboard plates with cardboard coating on both sides, gypsum fiber plates, ceramic fiber plates, cement plates or lime plates. The plates can optionally be reinforced with natural and/or synthetic fibers, which can also comprise mineral and/or ceramic fibers. The reinforcement fibers can be present in the form of filaments, monofilaments or as staple fibers.

In addition to the described materials the carrier can also consist of cork or other vegetable materials.

The weight per unit area of the carriers contained in the composite material is a function of the final application and is not subject to any particular limitation.

The textile surface structures used in accordance with step b) are all structures manufactured from fibers and from which a textile surface was produced by means of a surface-forming technology.

The textile surface structures to be provided with the B-stage binder can basically also be used without binders, in particular chemical binders.

However, in order to ensure the required strengths in the further processing of the surface structures binders can also be introduced and/or known needling methods can be used. In addition to the possibility of a mechanical strengthening, e.g., by calendering or needling, in particular the hydrodynamic needling is also mentioned here. Chemical and/or thermoplastic binders are suitable as binders.

However, the textile surface structures to be provided with the B-stage binder are preferably pre-strengthened with a chemical binder. The binders used can be the same or different but must be selected from the group of the binder systems compatible with the B-stage binder. The additional amount of binder is maximally 25% by weight, preferably 10% by weight or less; the minimum content is 0.5% by weight, preferably a minimum of 1% by weight.

The fiber-forming materials are preferably natural fibers and/or fibers of synthesized or natural polymers, ceramic fibers, mineral fibers or glass fibers that can also be used in the form of mixtures. Textile surfaces are considered to be fabrics, layings, knitted fabrics, knitwear and non-woven fabrics, preferably non-woven fabrics.

The textile surfaces of mineral and ceramic fibers are aluminosilicate fibers, ceramic fibers, dolomite fibers, wollastonite fibers or fibers of vulcanites, preferably basalt fibers, diabase fibers and/or melaphyr fibers, especially basalt fibers. Daibases and melaphyrs are designated combined as paleobasalts and diabase is also often designated as greenstone.

The mineral fiber non-woven fabric can be formed from filaments, that is, infinitely long fibers or of staple fibers. The average length of the staple fibers in the non-woven fabric of mineral fibers used in accordance with the invention is between 5 and 120 mm, preferably 10 to 90 mm. In a further embodiment of the invention the mineral fiber non-woven fabric contains a mixture of endless fibers and staple fibers. The average fiber diameter of the mineral fibers is between 5 and 30 μm, preferably between 8 and 24 μm, especially preferably between 8 and 15 μm.

The weight per unit area of the textile surface structure of mineral fibers is between 15 and 500 g/m², preferably 40 and 250 g/m², wherein these data refer to a surface structure without binders.

In the case of the textile surfaces of glass fibers non-woven fabrics are particularly preferred. They are constructed from filaments, that is, infinitely long fibers or of staple fibers. The average length of the staple fibers is between 5 and 120 mm, preferably 10 to 90 mm. In a further embodiment of the invention the glass fiber non-woven fabric contains a mixture of endless fibers and staple fibers.

The average diameter of the glass fibers is between 5 and 30 μm, preferably between 8 and 24 μm, especially preferably between 10 and 21 μm.

In addition to the previously cited diameters even so-called glass microfibers can be used. The preferred average diameter of the glass microfibers is between 0.1 and 5 μm. The microfibers forming the textile surface can also be present in mixtures with other fibers, preferably glass fibers. Moreover, a layer-shaped construction of microfibers and glass fibers is also possible.

The weight per unit area of the textile surface structure of glass fibers is between 15 and 500 g/m², preferably 40 and 250 g/m², wherein these data refer to a surface structure without binders.

Suitable glass fibers comprise those manufactured from A-glass, E-glass, S-glass, T-glass or R-glass.

The textile surface can be manufactured according to any known method. For glass non-woven fabrics this is preferably the dry or wet laying method.

Among the textile surfaces of fibers of synthetic polymers, non-woven fabrics, especially so-called spun bonds, that is, spunbonded non-woven fabrics produced by a tangled deposit of melt-spun filaments, are preferred. They consist of endless synthetic fibers of melt-spinnable polymer materials. Suitable polymer materials are, e.g., polyamides such as, e.g., polyhexamethylene diadipamide, polycaprolactam, aromatic or partially aromatic polyamides (“aramids”), aliphatic polyamides such as, e.g., nylon, partially aromatic or fully aromatic polyesters, polyphenylene sulfide (PPS), polymers with ether and keto groups such as, e.g., polyetherketones (PEK) and polyetheretherketone (PEEK), polyolefins such as, e.g., polyethylene or polypropylene, cellulose or polybenzimidazoles. In addition to the previously cited synthetic polymers, even those polymers are suited that are spun from solution.

The spunbonded non-woven fabrics preferably consist of melt-spinnable polyesters. In principle, all known types of polyester material suitable for the manufacture of fibers are considered as polyester material. Polyesters containing at least 95 mole % polyethyleneterephthalate (PET), especially those of unmodified PET, are especially preferable.

If the composite materials in accordance with the invention should additionally have a flame-retardant action, it is advantageous if they were spun from polyesters modified in a flame-retardant manner. Such polyesters modified in a flame-retardant manner are known.

The individual titers of the polyester filaments in the spunbonded non-woven fabric are between 1 and 16 dtex, preferably 2 to 10 dtex.

In a further embodiment of the invention the spunbonded non-woven fabric can also be a bonded fiber fabric hardened by melt binder and which contains carrier fibers and melded fibers. The carrier fibers and melded fibers can be derived from any thermoplastic, fiber-forming polymers. Such spunbonded non-woven fabrics hardened by melt binder are described, e.g., in EP-A-0,446,822 and EP-A-0,590,629.

In addition to endless filaments (spunbond method) the textile surface can also be constructed of staple fibers or mixtures of staple fibers and endless filaments. The individual titers of the staple fibers in the non-woven fabric are between 1 and 16 dtex, preferably 2 to 10 dtex. The staple length is 1 to 100 mm, preferably 2 to 500 mm, especially preferably 2 to 30 mm. The textile surface structure can also be constructed of fibers of different materials in order to be able to achieve special properties.

The filaments and/or staple fibers constructing the bonded fiber fabric can have a practically round cross-section or also other forms such as dumbbell-shaped, kidney-shaped, triangular or tri-lobed or multi-lobed cross-sections. Even hollow fibers and bi-component or multi-component fibers can be used. Furthermore, the melded fibers can also be used in the form of bi-component or multi-component fibers.

The fibers forming the textile surface structure can be modified by customary additives, e.g., by antistatic agents such as carbon black.

The weight per unit area of the textile surface structure of fibers of synthetic polymers is between 10 and 500 g/m², preferably 20 and 250 g/m².

The natural fibers are vegetable fibers, fibers derived from grasses, straw, wood, bamboo, reed and bast, or fibers of animal origin. Plant fibers is a collective concept and stands for seed fibers such as cotton, kapok or poplar fluff, bast fibers such as bamboo fiber, hemp, jute, linen or ramie, hart fibers such as sisal or manila, or fruit fibers such as coconut. Fibers of animal origin are wools, animal hairs, feathers and silks.

The weight per unit area of the textile surface structure of natural fibers is between 20 and 500 g/m², preferably 40 and 250 g/m².

The textile surfaces of fibers of natural polymers are cellulose fibers such as viscose or vegetable- or animal protein fibers.

Among the textile surfaces of cellulose fibers non-woven fabrics are especially preferred. They are constructed from filaments, that is, infinitely long fibers and/or from staple fibers. The average length of the staple fibers is between 1 and 25 mm, preferably 2 to 5 mm.

The average diameter of the cellulose fibers is between 5 and 50 μm, preferably between 15 and 30 μm.

In as far as the composite material in accordance with the invention is to be finished by powder lacquering or electrostatically, the composite material to be worked should have a sufficient electrical conductivity. It can be advantageous for this if the carrier used in accordance with a) already contains pigments or particles in order to elevate the electrical conductivity that bring about such an elevation

The previously described conductivity can also be present as functional materials in the textile surface structure equipped with B-stage binder. For this, these functional materials can be mixed and applied with the B-stage binder or the textile structure equipped with the B-stage binder is equipped with the functional material. The previously cited materials are usually metallic particles, carbon black or conductive organic resins such as phenol resins or inorganic or organic salts. Such additives already known from DE-A-3639816. Furthermore, even the salts disclosed in DE-A-10232874 and EP-A-1659146, especially alkali or alkaline earth salts such as lithium nitrate and sodium nitrate can be used. However, the previously cited materials should be compatible with the other materials.

The textile surface structure used according to b), which is applied at least on one side of the carrier, includes at least one binder in the B-stage state. B-stage binders denotes binders that are only partially strengthened or hardened and can still experience a final hardening, e.g., by thermal post-treatment. Such B-stage binders are described in detail in U.S. Pat. No. 5,837,620, U.S. Pat. No. 6,303,207 and U.S. Pat. No. 6,331,339. The B-stage binders disclosed there are also subject matter of the present description. B-stage binders are preferably binders based on furfuryl alcohol formaldehyde, phenol formaldehyde, melamine formaldehyde, urea formaldehyde and their mixtures. Preferably, aqueous systems are concerned. Further preferred binder systems are formaldehyde-free binders. B-stage binders are distinguished in that they can be subjected to a multistage hardening, that is, they still have a sufficient binding action after the first hardening or after the first hardenings so that they can be used for the further processing.

Such binders are usually hardened after the addition of a catalyst at temperatures of ca. 350° F. in one step.

In order to form the B-stage, such binders are optionally hardened after the addition of a catalyst. The amount of hardening catalyst is up to 10% by weight, preferably 1 to 10% by weight (relative to the total binder content). For example, ammonium nitrate as well as organic aromatic acids, e.g., maleic acid and p-toluene sulfonic acid are suitable as hardening catalyst since it allows the B-stage state to be more rapidly reached. In addition to ammonium nitrate, maleic acid and p-toluene sulfonic acid, all materials are suitable as hardening catalyst that have a comparable acidic function. In order to reach the B-stage the textile surface structure impregnated with the binder is dried under the influence of temperature without producing a complete hardening. The necessary process parameters are dependent on the binder system selected.

The lower temperature limit can be influenced by the selection of the duration or by adding more or stronger acidic hardening catalyst.

The application of the B-stage binder onto the textile surface structure designated in b) can take place with the aid of all known methods. In addition to spraying on, impregnating and pressing in, the binder can also be applied by coating or by rotary nozzle heads.

A further preferred method is the application of the B-stage binder by the application of foam. In the application of foam, a binder foam is produced with the aid of a foaming agent in a foam mixer that is applied by suitable coating aggregates onto the non-woven fabric. The application can also take place here by rotary nozzle heads.

In the foam coating of a B-stage-capable binder there are basically no limitations regarding the foaming agent. Preferred foaming agents are ammonium stearates or succinic acid esters added with 1%-5% by weight in dry mass to the binder. Furthermore, the already described catalysts are mixed in if required. The solids content of the foam is at least 40%, preferably at least 50%.

The process of foam application makes possible an extremely flexible process control and permits the realization of a plurality of different product properties. In addition to the targeted adjustment of the penetration depth of the foam into the textile surface the binder charge and porosity can vary within broad limits. In addition, the application of foam offers great advantages in the process control, especially regarding the constancy of the solids content during the impregnating or coating of the textile surface and the required compatibility requirements of the surface manufacturing process on the binder.

The functional material used according to b) can be applied at the same time with the B-stage binder, e.g., as mixture or as individual components, or before or after the application of the binder. In as far as the B-stage binder is applied by foam application it is advantageous to apply the functional material with the foam or distributed in the foam or to apply the functional material onto the still fresh foam.

In addition to the previously cited features, the composite material in accordance with the invention can include even further finishings with a functional material. To this end, a functional material applied onto the top of the textile surface structure equipped with the B-stage binder or introduced into the textile surface structure is used.

The functional material in accordance with the invention is preferably flameproofing agents, materials for controlling electrostatic charges, organic or inorganic pigments, especially colored pigments, electrically conductive pigments or particles.

In a variant of the method an additional binder is added to fix the functional materials on the textile surface structure. The same binder (B-stage binder) as is present in the textile surface structure is preferably selected here. The content of functional materials is determined by the subsequent use.

The flameproofing agents are inorganic flameproofing agents, organophosphorus flameproofing agents, nitrogen-based flameproofing agents or intumescence flameproofing agents. Halogenated (brominated and chlorinated) flameproofing agents can also be used but are less preferred on account of their risk evaluation. Examples for such halogenated flameproofing agents are polybrominated diphenylether, e.g., decaBDE, tetrabromobisphenol A and HBCD (hexabromocyclododecane).

Antistatic effects can be achieved and/or the properties for the powder lacquering can be adjusted by the use of agents for raising and/or controlling the electrical conductivity. These agents are customarily particles that are electrically conductive. Suitable materials are electrically conductive carbons such as carbon black, graphite and carbon nanotubes (C nanotubes), conductive plastics of fibers or particles of metal or metallic components. In addition to these, conductive organic resins such as phenol resins, or inorganic or organic salts can also be used. Such additives are already known from DE-A-3639816. Furthermore, even the salts disclosed in DE-A-10232874 and EP-A-1659146, especially alkali salts or alkaline earth salts such as lithium nitrate and sodium nitrate can be used. However, the previously cited materials should be compatible with the other materials.

The use of agents for raising and/or controlling the electrical conductivity reduces the surface resistance of the composite material in accordance with the invention. It turned out that composite materials in accordance with the invention with a surface resistance of up to 10¹⁰Ω (ohms), preferably up to 10⁸Ω (ohms) are very well suited for powder lacquerings.

In a further embodiment the composite material in accordance with the invention can comprise even further additional layers and auxiliary layers that should facilitate or support a direct pressure. These additional layers and auxiliary layers are, e.g., base coatings and/or adhesion promoters and or layers of so-called adhesion bridges. Preferably, only base coatings are applied as pressure support in the form of one or more additional layers and auxiliary layers. These layers are only necessary as an aid. Due to the surface quality of the composite material in accordance with the invention, so-called primer layers can be entirely or at least partially eliminated. Furthermore, the layer thickness of the base coatings and therefore also the material expense can be reduced. Furthermore, expensive multilayer base coatings are avoided and the total expense reduced.

Further subject matter of the present invention is a method for manufacturing the composite material in accordance with the invention comprising the measures:
a) supplying of a carrier,
b) application of a textile surface structure on at least one surface of the carrier, wherein the textile surface structure has at least one binder in the B-stage state and optionally at least one functional material is introduced,
c) lamination of the structure obtained according to step c) under the action of pressure and heat so that the binder present in the B stage receives its final hardening,
d) optional application of at least one additional layer and/or auxiliary layer(s) required for the direct printing or direct lacquering onto the side(s) of the composite material equipped with the textile surface structure.

The lamination of the construction obtained according to step b) takes place in step c) under the action of pressure and heat in such a manner that the binder present in the B stage receives its final hardening. The lamination can take place by discontinuous or continuous pressing or by rolling. The parameters of pressure, temperature and dwell time are selected in accordance with the B-stage binder used. On account of the surface quality, the surface of the presses or rollers should be selected in such a manner that the tolerances can be maintained.

In a variant the application of a textile surface structure can take place according to step b) even during the manufacture of the carrier. In other words, instead of the finished carrier in step a) the carrier is not formed until in step a).

The pressing of the formed carrier takes place together with the equipped textile surface structure, the textile surface structure being correspondingly introduced into the pressing and/or drying apparatus for the carrier. The manufacture of the carrier-non-woven fabric composite can take place continuously or discontinuously.

In a variant the textile surface structure applied in accordance with step b) can already comprise a finishing with functional material.

The layers applied according to step d) are additional layers and auxiliary layers that should simplify or support a direct pressure, e.g., base coatings and/or adhesion promoters or layers of so-called adhesion bridges. Preferably, only the base coating and/or adhesion promoter is applied as pressure support in the form of one or more additional layers and auxiliary layers. These layers are only necessary as an aid. Due to the surface quality of the composite material in accordance with the invention, so-called primer layers can be entirely or at least partially eliminated. Furthermore, the layer thickness of the base coatings and therefore also the material expense can be reduced. Furthermore, expensive multilayer base coatings are avoided and the total expense reduced.

The application of these additional layers and/or auxiliary layers in step d) and their drying takes place by known technologies.

Conditioned by the construction of the composite material in accordance with the invention, several special functions can be made available and utilized:
Barrier layer between carrier and outer layer against H₂O and other solvents
Electrical conductivity
Adhesion promotion between carrier and base coating
Reduction of the layer construction when used in the direct printing process
Improvement of the impact strength (charpy impact)
Avoidance of additional grinding processes.

The direct printing of wooden materials customarily requires a multilayer construction of the surface to be printed. Moreover, in addition to one or several primer layers (base coat), one or more base coatings are necessary on which the direct printing can then take place. A direct printing takes place here in one or even several individual printing steps. An outer lacquering completes the system. The multilayer construction is necessary in order to achieve an appropriate surface quality, and barrier layer properties in order to prevent diffusion processes and an improvement of the print qualities.

The use of the textile surfaces containing the B-stage binder in accordance with the invention produces an excellent surface quality. At the same time it is possible to produce the required barrier layer properties that thus make possible a simplified direct printing. The use of the textile surfaces in accordance with the invention thus permits the reduction of at least one primer layer and/or of at least one base coating layer or makes possible the complete replacement of these layers, in particular of the primer layer. A primer layer can preferably be completely eliminated by the textile surface in accordance with the invention. The number of the required base coating layers can also be optionally reduced.

When using conductive additives the textile surface in accordance with the invention can also be lacquered with the aid of a powder lacquering. Moreover, it is also possible to use electrostatic lacquering methods that are otherwise not possible without additional measures.

The impact strength can be drastically raised on account of the mechanical properties of the textile surface in accordance with the invention.

It is possible on account of the special nature of the laminated textile surfaces to reduce or entirely avoid necessary subsequent working of the surfaces. It is customarily necessary, in particular in the manufacturing of MDF, to remove the outer, soft layers damaged on account of the manufacturing method by means of a grinding process. This step can be omitted when using the textile surfaces in accordance with the invention or at least made less expensive.

Further subject matter of the present invention is the use of the composite materials in accordance with the invention comprising:
a) a carrier,
b) at least one textile surface structure applied on at least one of the two sides of the carrier, the surface structure having at least one finally hardened B-stage binder,

for lacquering, coating with printed or lacquered foils or for printing, which takes place directly on the side of the composite material coated with the textile surface structure.

The concept “direct” denotes that the surface must not be subjected before the printing, lacquering or coating with foil to any mechanical subsequent working, in particular not to any abrasive subsequent working. A finishing with primer layers or base coating layers is not excluded, preferably the composite materials in accordance with the invention are processed without a primer layer being applied. In as far as a finishing with primer layers (filler) is omitted, auxiliary layers, e.g., base coating layers and/or adhesion promoter layers or adhesion bridge layers can nevertheless be applied that bring about, among other things, a better adherence of the lacquering, coating with printed or lacquered foils or of the print on the surface.

The printing takes place by known technologies. Suitable printing technologies are in particular inkjet, silk screen and/or digital printing. The powder coating also takes place by known technologies. The drying of the printing layer or powder layer takes place as a function of the selected system.

The composite materials in accordance with the invention are used after surface finishing, e.g., after printing, lacquering or coating as construction material, in particular for furniture, wall coverings, ceiling coverings and floor coverings.

On account of the high surface quality the composite materials in accordance with the invention, optionally after finishing with a protective layer, can also be directly used as construction material, in particular for furniture, wall coverings, ceiling coverings and floor coverings. This is preferably the case if the carrier already has the desired decorative appearance.

Thus, printed or lacquered composite materials are further subject matter of the present invention, comprising:
a) a carrier,
b) at least one textile surface structure applied on at least one of the two sides of the carrier, which surface structure has at least one finally hardened B-stage binder,
c) optionally at least one functional material present in the carrier and/or the textile surface,
d) optionally one or more base coatings applied on the side of the textile surface structure facing away from the carrier,
e) at least one lacquer or printed layer and/or a printed or lacquered foil,
f) optionally further layers for the protection of the lacquer layer or printed layer,

characterized that the layer according to e) is applied directly on the textile surface structure without primer layers being used between the layer according to e) and the textile surface or according to c) and the base coating according to d) applied on the textile surface structure.

The layers for the protection of the lacquer layer or printed layer are usually lacquers such as powder lacquers, clear lacquers or transparent lacquers, preferably scratch-proof lacquers that protect against mechanical influences or against UV aging.

Further subject matter of the present invention is a method for printing or lacquering composite materials, characterized in that a composite material comprising:
a) a carrier,
b) at least one textile surface structure applied on at least one of the two sides of the carrier, which surface structure comprises at least one finally hardened B-stage binder,
c) optionally at least one functional material present in the carrier and/or the textile surface,
d) optionally one or more base coatings applied on the side of the textile surface structure facing away from the carrier,

is directly printed or lacquered without primer layers being used on the textile surface or between the textile surface and the base coating optionally applied according to d).

The furniture, wall coverings, ceiling coverings and floor coverings manufactured using the composite materials in accordance with the invention are also subject matter of the present invention.

While various embodiments have been described, it is to be understood that variations and modifications may be resorted to as will be apparent to those skilled in the art. Such variations and modifications are to be considered within the purview and scope of the claims appended hereto.

1. A composite material comprising:
a) a carrier,
b) at least one textile surface structure laminated on at least one of the two sides of the carrier, which textile surface structure having at least one finally hardened B-stage binder and can be optionally provided with at least one functional material,
characterized in that the side(s) of the composite material equipped with the textile surface structure have a surface quality such that the latter can be directly printed or lacquered.

2. The composite material according to claim 1, characterized in that the surface quality of the composite material on the side(s) of the composite material equipped with the textile surface structure, expressed as thickness variation, is less than 0.1 mm.

3. The composite material according to claim 1 or 2, characterized in that the carrier is wooden materials, papers, cork, cardboards, mineral plates and/or honeycombs.

4. The composite material according to claim 3, characterized in that the wooden materials are plate-shaped or strand-shaped wooden materials.

5. The composite material according to claim 4, characterized in that the wooden materials are plywood, laminated wood, wood-chip material, preferably chipboards and OSB (Oriented Strand Boards), wood fiber material, preferably porous wood fiber boards, open-diffusion wood fiber boards, hard (high-density) wood fiber boards (HDF) and medium-density wood fiber boards (MDF), and Arboform.

6. The composite material according to claim 1 or 2, characterized in that the carrier is materials of wood fiber materials, cellulose fibers, natural fibers or their mixtures and of a thermoplastic binder, that the amount of the binder being more than 15% by weight.

7. The composite material according to claim 3, characterized in that the papers and cardboards are materials on the basis of natural, synthetic, mineral or ceramic fibers or also of mixtures of these fiber types.

8. The composite material according to claim 3, characterized in that the mineral plates are plates with cardboard coating on both sides, especially gypsum fiber plates, ceramic fiber plates, cement plates or lime plates that can optionally be reinforced with natural and/or synthetic fibers, wherein the latter can also comprise mineral and/or ceramic fibers.

9. The composite material according to claim 1 or 2, characterized in that the textile surface structure is a fabric, laying, knitted fabric, knitwear and/or non-woven fabric.

10. The composite material according to claim 1, 2 or 9, characterized in that the textile surface structure is formed from natural fibers and/or fibers of synthesized or natural polymers, ceramic fibers, mineral fibers or glass fibers, wherein these can also be used in the form of mixtures.

11. The composite material according to claim 1, 2 or 9, characterized in that the textile surface structure is a mineral fiber of filaments and/or or staple fibers.

12. The composite material according to claim 11, characterized in that the average length of the staple fibers is between 5 and 120 mm.

13. The composite material according to claim 11, characterized in that the average fiber diameter of the mineral fibers is between 5 and 30 μm.

14. The composite material according to claim 1, 2 or 9, characterized in that the textile surface structure is a glass fiber non-woven fabric of filaments and/or of staple fibers.

15. The composite material according to claim 14, characterized in that the average length of the staple fibers is between 5 and 120 mm.

16. The composite material according to claim 14, characterized in that the average diameter of the glass fibers is between 5 and 30 μm.

17. The composite material according to claim 14, characterized in that the glass fiber non-woven fabric comprises glass microfibers whose average diameter is between 0.1 and 5 μm.

18. The composite material according to claim 14, characterized in that the glass fiber non-woven fabric has a weight per unit area of 15 to 500 g/m², wherein these data refer to a surface structure without blinders.

19. The composite material according to claim 14, characterized in that the glass fiber non-woven fabric was manufactured by dry or wet laying methods.

20. The composite material according to claim 1, 2 or 9, characterized in that the textile surface structure has fibers of synthetic polymers.

21. The composite material according to claim 20, characterized in that the textile surface structure comprises a non-woven fabric, in particular a spunbonded non-woven fabric.

22. The composite material according to claim 21, characterized in that the spunbonded non-woven fabric additionally comprises staple fibers, preferably with an individual titer between 1 and 16 dtex and/or a staple length between 1 to 100 mm.

23. The composite material according to claim 20, characterized in that the non-woven fabric comprises fibers of polyamides, polycaprolactam, aromatic or partially aromatic polyamides (“aramids”), aliphatic polyamides, partially aromatic or fully aromatic polyesters, polyphenylene sulfide (PPS), polymers with ether and keto groups, polyolefins, cellulose or polybenzimidazoles.

24. The composite material according to claim 1, 2 or 9, characterized in that the textile surface structure has natural fibers.

25. The composite material according to claim 1, 2 or 9, characterized in that the textile surface structure has cellulose fibers, preferably in the form of staple fibers with an average length between 1 and 25 mm.

26. The composite material according to claim 1 or 2, characterized in that the B-stage binder can still experience a final hardening, e.g. by thermal posttreatment.

27. The composite material according to claim 26, characterized in that the binder is a binder based on furfuryl alcohol formaldehyde, phenol formaldehyde, melamine formaldehyde and their mixtures.

28. The composite material according to claim 1, characterized in that the binder includes additives for raising the electrical conductivity.

29. The composite material according to claim 1, characterized in that flameproofing agents, materials for controlling and/or elevating the electrostatic charges, organic or inorganic pigments, especially colored pigments, materials for controlling and/or elevating the electrical conductivity are used as functional material.

30. The composite material according to claim 29, characterized in that it contains materials for controlling and/or elevating the electrical conductivity as functional material and the surface resistance of the composite material in accordance with the invention is up to 10¹⁰Ω (ohms).

31. The composite material according to claim 1, characterized in that it comprises further additional layers and auxiliary layers on the side of the textile surface structure facing away from the carrier.

32. The composite material according to claim 31, characterized in that these additional layers and auxiliary layers are base coatings and/or adhesion promoter layers or layers of adhesion bridge materials.

33. The composite material according to claim 31, characterized in that these additional layers and auxiliary layers are base coating.

34. A method for manufacturing a composite material comprising the measures:
a) Supplying of a carrier,
b) Application of a textile surface structure onto at least one surface of the carrier, wherein the textile surface structure has at least one binder in the B-stage state and optionally at least one functional material is introduced,
c) Lamination of the construction obtained according to step c) under the action of pressure and heat so that the binder present in the B stage receives its final hardening,
d) Optional application of at least one additional layer and/or auxiliary layer(s) required for the direct printing or direct lacquering onto the side(s) of the composite material equipped with the textile surface structure.

35. The method according to claim 31, characterized in that the application of a textile surface structure according to step b) takes place during the manufacture of the carrier.

36. The use of the composite material according to any one of the claims 1 to 33 for the direct printing, lacquering and/or coating of the side of the textile surface structure facing away from the carrier.

37. The use according to claim 36, characterized in that no primer layers are applied onto the side of the textile surface structure to be worked.

38. The use according to claim 36, characterized in that the side of the textile surface structure to be worked does not have to be subjected to any abrasive subsequent working.

39. The use according to claim 36, 37 or 38, characterized in that the printing takes place by inkjet, silk screen and/or digital printing.

40. Printed or lacquered composite materials comprising:
a) a carrier,
b) at least one textile surface structure applied onto at least one of the two sides of the carrier, which textile surface structure has at least one finally hardened B-stage binder,
c) optionally at least one functional material that is present in the carrier and/or the textile surface,
d) optionally one or more base coatings that are applied on the side of the textile surface structure facing away from the carrier,
e) at least one lacquer or printed layer and/or one printed or lacquered foil,
f) optionally further layers for the protection of the lacquer- or printed layer as well as of the printed or lacquered foil,
characterized in that the layer according to e) is applied directly on the textile surface structure without primer layers being used between the layer according to e) and the textile surface or according to c) or the base coating applied on the textile surface structure according to d).

41. The composite materials according to claim 40, characterized in that the printing or the printed foil is printed by inkjet, silk screen and/or digital printing.

42. The composite materials according to claim 40, characterized in that the layers according to f) protect the lacquer layer or printed layer according to e) against mechanical influences or against UV aging.

43. A method for printing or lacquering composite materials, characterized in that a composite material comprising
a) a carrier,
b) at least one textile surface structure applied on at least one of the two sides of the carrier, which textile surface structure has at least one finally hardened B-stage binder,
c) optionally at least one functional material present in the carrier and/or in the textile surface,
d) optionally one or more base coatings applied on the side of the textile surface structure facing away from the carrier,
is directly printed or lacquered without primer layers being used on the textile surface or between the textile surface and the base coating optionally applied according to d).

44. The method according to claim 43, characterized in that after the printing or lacquering at least one further layer is applied for protecting the lacquered layer or printed layer against mechanical influences or against UV aging.

45. The use of the composite materials defined in claims 1 to 33 as well as in claims 40 to 42 as construction material, especially in the furniture industry and for interior finishing, for the manufacture of surfaces for furniture, wall coverings, ceiling coverings and floor coverings and as lining material.

46. Furniture as well as wall, ceiling and floor coverings containing at least one composite material defined in claims 1 to 33 as well as in claims 40 to 42.
